(19) United States
(12) Patent Application Publication
(10) Pub. No.: US 2015/0277414 A1
(43) Pub. Date: Oct. 1, 2015

(54) METHOD AND DEVICE FOR MANAGING AND CONFIGURING FIELD DEVICES IN AN AUTOMATION INSTALLATION

(71) Applicant: ABB TECHNOLOGY AG, Zurich (CH)

(72) Inventors: Dirk WAGENER, Stadthagen (DE); Christoph WELTE, Neu-Ulm (DE); Marcus HEEGE, Kaisersesch (DE); Wolfgang MAHNKE, Hettenleidelheim (DE); Marko SCHLUTER, Espelkamp (DE)

(73) Assignee: ABB TECHNOLOGY AG, Zurich (CH)

(21) Appl. No.: 14/671,668

(22) Filed: Mar. 27, 2015

(30) Foreign Application Priority Data
Apr. 1, 2014 (DE) 102014004754.7

(51) Int. Cl. G05B 19/05

(52) U.S. Cl. CPC G05B 19/05; G05B 2219/13109

(57) ABSTRACT

An exemplary method and device provide for managing and configuring field devices in an automation installation. In order to make the management and configuration of field devices in an automation installation with a configuration tool flexible, a tool-specific information packet is formed from a first field-device-specific information packet and a second field-device-specific information packet. The second field-device-specific information packet including functions and data which go beyond the stipulation of the first field-device-specific information packet. The field device is managed and configured using the tool-specific information packet.

### RELATED APPLICATION(S)

This application claims priority under 35 U.S.C. §119 to German application 102014004754.7 filed on Apr. 1, 2014, the entire content of which is hereby incorporated by reference.

### FIELD

The disclosure relates to a method and device for managing and configuring field devices in an automation installation. The disclosure is germane to process automation or machine control for controlling processes and/or installation components.

### BACKGROUND INFORMATION

Automation systems for controlling a technical process or a technical installation usually include a control device (PLC) which is integrated in a group of a multiplicity of intelligent electrical devices, also called Intelligent Electronic Devices (IED). Intelligent electronic devices are microprocessor-based devices, for example protective and control devices, motor protective devices, intelligent switches and voltage regulators, frequency converters, pressure and temperature measuring transducers, flowmeters, and actuators.

Communication between the control device and the intelligent electrical devices (IEDs) is usually carried out using a communication protocol, such as the IEC 61850 communication standard, which is described in EP 1 976 281 A1, for example. In order to interchange data within the system, the IEDs should be configured using a programming tool or programming device, also called an engineering tool, and to incorporate the devices in the communication network operating according to the IEC 61850 standard.

In order to interchange information between the devices, from which the control or automation system is formed, such as interchanging data between functions implemented in the devices, the communication nodes are first considered to be the smallest part of a function which interchanges data with other functions. These logical nodes carry out sub-functions for the overall function and can be implemented individually or together in devices.

DE 101 17 459 A1 discloses a method and an apparatus for obtaining diagnostic information, which apparatus uses an engineering tool which visualizes the device-related information as objects of a multi-branched tree structure in a hierarchical arrangement. In this tree structure, the user has access to parameters and menus in order to adjust the device and perform diagnoses or other functions.

The article “FDI Device Integration—Best of Both Worlds”, atp edition June 2010, pages 16 to 19, discloses the practice of integrating field devices in an automation installation using the FDI concept (Field Device Integration). The basis of this concept is the provision of information for configuring field devices in a device-specific FDI packet. This FDI packet includes a firmly predefined amount of information which consists of a device definition, business logic, a user interface description and user interface plug-ins. The device definition includes management information and the device model. The business logic describes the communication logic for the device and is used to ensure consistency of the device model. The user interface description describes the presentation of the device parameters and device functions. The user interface plug-ins are programmed components of interface portions for displaying the device parameters and functions.

In known implementations, FDI packets are created by device manufacturers and are used by system manufacturers to integrate and configure the devices from the device manufacturers in their system.

The set of information which can be included in an FDI packet is described by a specification and is restricted to the stipulation of this specification. Such an FDI packet contains only the basic information for configuring the device. Additional information going beyond configuration data is not provided by the specification.

### SUMMARY

An exemplary method for managing and configuring field devices in an automation installation with a configuration tool is disclosed, the method comprising: in a processor of the configuration tool: physically detecting a field device in the automation installation; logically incorporating the field device in the automation installation; and configuring the field device in the automation installation using a predefined first field-device-specific information packet which partially describes first functions and data of the field device; receiving a second field-device-specific information packet that includes second functions and data which go beyond the first functions and data of the first field-device-specific information packet; forming a tool-specific information packet from the first field-device-specific information packet and the second field-device-specific information packet; and managing and configuring the field device using the tool-specific information packet.

An exemplary device for managing and configuring field devices in an automation installation, the device comprising: a processor configured to execute a configuration tool that physically detects a field device in the automation installation, logically incorporates the field device in the automation installation, configures the field device in the automation installation, using a predefined first field-device-specific information packet which partially describes first functions and data of the field device, and form a tool-specific information packet from the first field-device-specific information packet and a second field-device-specific information packet, wherein the second field-device-specific information packet is received from an external device and includes second functions and data which go beyond the stipulation of the first field-device-specific information packet, and wherein the tool-specific information packet is a comprehensive description of the functions and data of the field device.

### BRIEF DESCRIPTION OF THE DRAWINGS

The disclosure is explained in more detail below using exemplary embodiments and in connection with the appended drawings in which:

FIG. 1 illustrates a tool-specific information packet according to an exemplary embodiment of the present disclosure; and

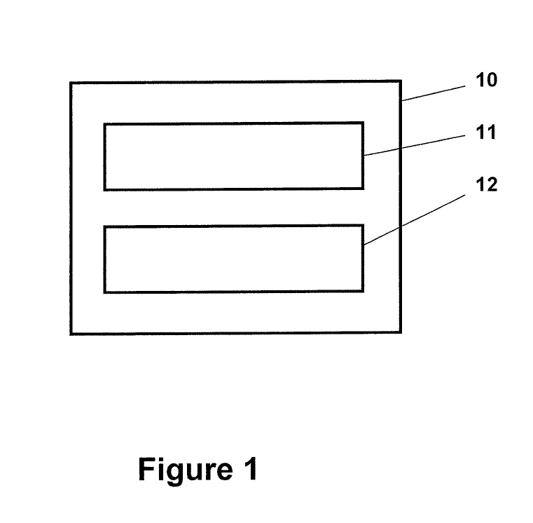

FIG. 2 illustrates a flowchart of method for managing and configuring field devices in an automation installation in accordance with an exemplary embodiment of the present disclosure.

### DETAILED DESCRIPTION

Exemplary embodiments of the present disclosure make the management and configuration of field devices in an automation installation with a configuration tool as flexible as possible.

Exemplary embodiments of the present disclosure provide management and configuration of field devices in an automation installation with a configuration tool designed to physically detect a field device in the automation installation, logically incorporate the field device in the automation installation, and configure the field device in the automation installation. For this purpose, the configuration tool uses a predefined first field-device-specific information packet which partially describes the functions and data of the field device.

An exemplary method of the present disclosure provides for a tool-specific information packet to be formed from the first field-device-specific information packet and a second field-device-specific information packet, the second field-device-specific information packet including functions and data which go beyond the stipulation of the first field-device-specific information packet, and for the field device to be managed and configured using the tool-specific information packet.

An exemplary device of the present disclosure provides for a second field-device-specific information packet having functions and data which go beyond the stipulation of the first field-device-specific information packet to be provided, for the configuration tool to be designed to form a tool-specific information packet from the first field-device-specific information packet and a second field-device-specific information packet, and for the tool-specific information packet to be a comprehensive description of the functions and data of the field device.

Exemplary embodiments described herein define the system and method for generating and using a tool-specific information packet which includes both the FDI packet and additional information which can be used by the tool.

In addition to the basic data which form the first field-device-specific information packet, functions and data which go beyond said data and form the second field-device-specific information packet are available to the user of the configuration tool.

In this case, provision can be made for these additional functions and data to be provided by the device manufacturer.

According to another exemplary embodiment of the present disclosure, provision can be made for these additional functions and data to be provided by the tool manufacturer who uses the additional functions and data.

Still according to another exemplary embodiment of the present disclosure, the tool manufacturer can provide a development environment for providing such packets.

According to an exemplary embodiment disclosed herein, the tool packet can be generated on the basis of the Open Package Convention which is also used to generate an FDI packet. However, the disclosure is not restricted to this implementation and equally includes other possible implementations, for example a separate binary format.

The Figure illustrates a tool-specific information packet according to an exemplary embodiment of the present disclosure. As shown in the Figure, a tool-specific information packet 10 includes a first field-device-specific information packet 11 and a second field-device-specific information packet 12.

The first field-device-specific information packet 11 includes precisely one FDI packet according to the FDI specification.

The second field-device-specific information packet 12 includes functions and data which go beyond the stipulation of the first field-device-specific information packet 11. Selected but not conclusive exemplary embodiments which show the flexibility of the second field-device-specific information packet 12 are indicated below.

According to an exemplary embodiment of the disclosure, the tool-specific information packet 10 includes additional localization information. An EDD contains data which have already been localized. However, the number of languages and the quality are predefined by the device manufacturer. Additional localization data can be enclosed with the tool packet and can be used by the tool. For example, an FDI package is delivered in English and German by the device manufacturer and the tool packet adds Swedish as a language.

According to another exemplary embodiment of the disclosure, the tool-specific information packet 10 includes additional help information. An FDI packet can already include documentation. Tool-specific information for help can be added, with the result that context-sensitive help can be displayed in the tool, for example.

In yet another exemplary embodiment of the disclosure, the tool-specific information packet 10 includes additional search information. In this case, a search index which resorts to available search information is added to the tool packet.

In another exemplary embodiment of the disclosure, the tool-specific information packet 10 additionally includes favorites in the user guidance. In addition to the navigation functions provided by the device manufacturer, it is possible to enclose tool-specific navigation information which includes, for example, the standard input masks or newly generated input masks with the most frequently called for parameters.

In still another exemplary embodiment of the disclosure, the tool-specific information packet 10 includes additional information relating to the offline configuration of a device. In FDI, not every FDI packet 11 should provide sufficient information relating to offline configuration. In this case, a device configuration should be first be loaded from the device before it can then be used for offline configuration. Offline configurations can already be enclosed for such FDI packets 11. As a result, offline configuration is possible in the tool even without the previous connection to the device. Additional offline configurations could also be added when the FDI packet 11 already has some of these configurations, but additional configurations appear to be useful.

In another exemplary embodiment of the present disclosure, the tool-specific information packet 10 additionally includes menus. An FDI packet 11 should not contain any menu information whatsoever. In this case, provision can be made for one or more suitable menus to be added to the tool-specific information packet 10.

In another exemplary embodiment of the disclosure, the tool-specific information packet 10 additionally includes details of the upload and/or download functionality. An FDI packet 11 should not contain any explicit information relating to the order when uploading and downloading parameters. In this case, the tool should determine the correct order using algorithms. This can fail in the case of some FDI packets 11 which have not been completely described and do not contain the full business logic in the EDD. The disclosure can provide for the correct order for uploading and/or downloading parameters to be added to the tool-specific information packet 10, with the result that the tool is also able to carry out the upload and/or download for such FDI packets 11.

The stated embodiments of the disclosure can be integrated in the tool-specific information packet 10 individually or in combination. The disclosure is not restricted to the stated embodiments.

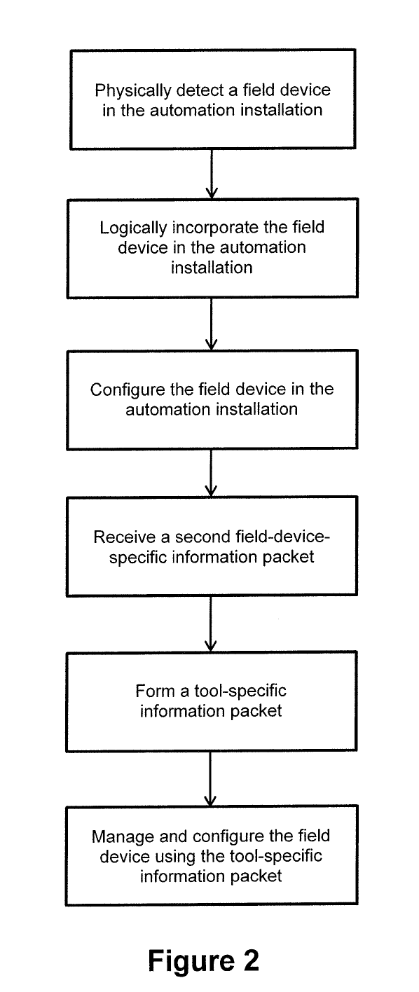

FIG. 2 illustrates a flowchart of method for managing and configuring field devices in an automation installation in accordance with an exemplary embodiment of the present disclosure. The configuration tool is configured for physically detecting a field device in the automation installation, logically incorporating the field device in the automation installation, and configuring the field device in the automation installation using a predefined first field-device-specific information packet which partially describes first functions and data of the field device. The configuration tool receives a second field-device-specific information packet that includes second functions and data which go beyond the first functions and data of the first field-device-specific information packet, and forms a tool-specific information packet from the first field-device-specific information packet and the second field-device-specific information packet. The field device is managed and configured using the tool-specific information packet.

According to exemplary embodiments of the present disclosure the configuration tool can be implemented in software and/or hardware including one or more of any known general purpose processor or integrated circuit such as a central processing unit (CPU), microprocessor, field programmable gate array (FPGA), Application Specific Integrated Circuit (ASIC), or other suitable programmable processing or computing devices or circuits as desired having an associated and suitable display monitor or display device. The general processor(s) can be configured to include and perform features of the exemplary embodiments of the present disclosure such as, a method for managing and configuring field devices in an automation installation, and thereby function as a special and unique processor. The features can be performed through program code encoded or recorded on the processor(s), or stored in a non-volatile memory device, such as Read-Only Memory (ROM), erasable programmable read-only memory (EPROM), or other suitable memory device or circuit as desired. In another exemplary embodiment, the program code can be provided in a computer program product having a non-transitory computer readable medium, such as Magnetic Storage Media (e.g. hard disks, floppy discs, or magnetic tape), optical media (e.g., any type of compact disc (CD), or any type of digital video disc (DVD), or other compatible non-volatile memory device as desired) and downloaded to the processor(s) for execution as desired, when the non-transitory computer readable medium is placed in communicable contact with the processor(s).

Thus, it will be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

### LIST OF REFERENCE SYMBOLS

10 Tool-specific information packet
11 First field-device-specific information packet
12 Second field-device-specific information packet

What is claimed is:

1. A method for managing and configuring field devices in an automation installation with a configuration tool, the method comprising:
in a processor of the configuration tool:
physically detecting a field device in the automation installation;
logically incorporating the field device in the automation installation; and
configuring the field device in the automation installation using a predefined first field-device-specific information packet which partially describes first functions and data of the field device;
receiving a second field-device-specific information packet that includes second functions and data which go beyond the first functions and data of the first field-device-specific information packet;
forming a tool-specific information packet from the first field-device-specific information packet and the second field-device-specific information packet; and
managing and configuring the field device using the tool-specific information packet.

2. The method as claimed in claim 1, wherein the second field-device-specific information packet is provided by a device manufacturer.

3. The method as claimed in claim 1, wherein the second field-device-specific information packet is provided by a tool manufacturer.

4. The method as claimed in claim 1, wherein the tool packet is generated based on an Open Package Convention.

5. A device for managing and configuring field devices in an automation installation, the device comprising:
a processor configured to execute a configuration tool that physically detects a field device in the automation installation, logically incorporates the field device in the automation installation, configures the field device in the automation installation, using a predefined first field-device-specific information packet which partially describes first functions and data of the field device, and form a tool-specific information packet from the first field-device-specific information packet and a second field-device-specific information packet,
wherein the second field-device-specific information packet is received from an external device and includes second functions and data which go beyond the stipulation of the first field-device-specific information packet, and
wherein the tool-specific information packet is a comprehensive description of plural functions and data of the field device.
